(19) United States
(12) Patent Application Publication
(10) Pub. No.: US 2010/0247080 A1
(43) Pub. Date: Sep. 30, 2010

(54) METHOD AND APPARATUS FOR CREATING AND CONSUMING MULTIVIEW IMAGE MEDIA FILE

(76) Inventors: Kug-Jin YUN, Daejon (KR); Hyun LEE, Daejon (KR); Bong-Ho LEE, Daejon (KR); Gwang-Soon LEE, Daejon (KR); Namho HUR, Daejon (KR); Jin-Woong KIM, Daejon (KR); Soo-In LEE, Daejon (KR)

Correspondence Address: LADAS & PARRY LLP, 224 SOUTH MICHIGAN AVENUE, SUITE 1600, CHICAGO, IL, 60604, US

(21) Appl. No.: 12/732,917

(22) Filed: Mar. 26, 2010

(30) Foreign Application Priority Data
Mar. 27, 2009 (KR) 10-2009-0026374

(51) Int. Cl. H04N 5/91; H04N 13/00

(52) U.S. Cl. 386/108; 348/43; 386/E05.003; 348/E13.001

(57) ABSTRACT

A method for creating a multiview image media file includes: receiving tiled multiview image data; dividing the tiled multiview image data into at least one image group including at least one view image; and creating a media file including the at least one image group. The media file includes multiview type information, which is information regarding the tiled multiview image data.

### CROSS-REFERENCE(S) TO RELATED APPLICATIONS

The present application claims priority of Korean Patent Application No. 10-2009-0026374, filed on Mar. 27, 2009, which is incorporated herein by reference in its entirety.

### BACKGROUND OF THE INVENTION

1. Field of the Invention

Exemplary embodiments of the present invention relate to a method and an apparatus for creating and consuming multiview image media files.

2. Description of Related Art

Multiview images refer to contents providing users with various views in different directions. Images of multiple views are created by obtaining images with at least one camera or through Computer Graphics (CG) and geometrically calibrating the obtained images. Compared with existing stereoscopic images, multiview images are characterized in that they provide users with more free viewpoints.

There are two types of methods for providing multiview images. According to the first method, images and depth information are used to create depth-based multiview images by terminals. According to the second method, images of multiple views are obtained with at least one camera or through CG, the obtained images are encoded based on a multiview encoding technique, and the encoded images are transmitted/received to create multiview 3D images.

However, the conventional methods have a problem in that the complexity of systems for providing multiview images increases. Furthermore, use of a multiview encoding technique requires a high level of complexity of encoding/decoding algorithms.

### SUMMARY OF THE INVENTION

An embodiment of the present invention is directed to a method and an apparatus for creating and consuming multiview image media files, which can provide a tiled multiview image service more efficiently while guaranteeing compatibility with existing multiview image systems.

Another embodiment of the present invention is directed to a method and an apparatus for creating and consuming multiview image media files, which can provide multiview images of better quality compared with conventional depth-based multiview image services.

Another embodiment of the present invention is directed to a method and an apparatus for creating and consuming multiview image media files, which can decrease the complexity of multiview image service systems and substantially reduce the amount of data necessary for multiview image encoding.

In accordance with an embodiment of the present invention, a method for creating a multiview image media file includes: receiving tiled multiview image data; dividing the tiled multiview image data into at least one image group including at least one view image; and creating a media file including the at least one image group, wherein the media file includes multiview type information, the multiview type information being information regarding the tiled multiview image data.

In accordance with another embodiment of the present invention, a method for consuming a multiview image media file includes: receiving a media file including tiled multiview image data and multiview type information, the tiled multiview image data including at least one image group including at least one view image, the multiview type information being information regarding the tiled multiview image data; and controlling playback of the tiled multiview image data using the multiview type information.

In accordance with another embodiment of the present invention, an apparatus for creating a multiview image media file includes: an input unit configured to receive tiled multiview image data; a control unit configured to divide the tiled multiview image data into at least one image group including at least one view image; and a media file creation unit configured to create a media file including the at least one image group, wherein the media file includes multiview type information, the multiview type information being information regarding the tiled multiview image data.

In accordance with another embodiment of the present invention, an apparatus for consuming a multiview image media file includes: an input unit configured to receive a media file including tiled multiview image data and multiview type information, the tiled multiview image data including at least one image group including at least one view image, the multiview type information being information regarding the tiled multiview image data; and a control unit configured to control playback of the tiled multiview image data using the multiview type information.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 illustrates the construction of a tiled multiview image, which is used in a method for creating and consuming multiview image media files in accordance with an embodiment of the present invention.

FIG. 2 illustrates the construction of a system including an apparatus for creating multiview image media files in accordance with an embodiment of the present invention.

FIG. 3 illustrates the construction of a system including an apparatus for consuming multiview image media files in accordance with an embodiment of the present invention.

FIG. 4 illustrates an exemplary conventional file storage structure for providing a one- or two-dimensional moving image service.

FIG. 5 illustrates a multiview image file storage structure in accordance with an embodiment of the present invention.

FIG. 6 illustrates multiview type information in accordance with an embodiment of the present invention.

FIG. 7 illustrates the construction of playback order information based on the order of playing view images included in an image group.

FIG. 8 illustrates the construction of playback order information based on the order of playing view images included in an image group.

FIG. 9 is a flowchart illustrating a method for creating multiview image media files in accordance with an embodiment of the present invention.

FIG. 10 is a flowchart illustrating a method for consuming multiview image media files in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

A tiled multiview image refers to an image obtained by obtaining images of multiple views with cameras or through CG and reconstructing the obtained images in a predetermined arrangement.

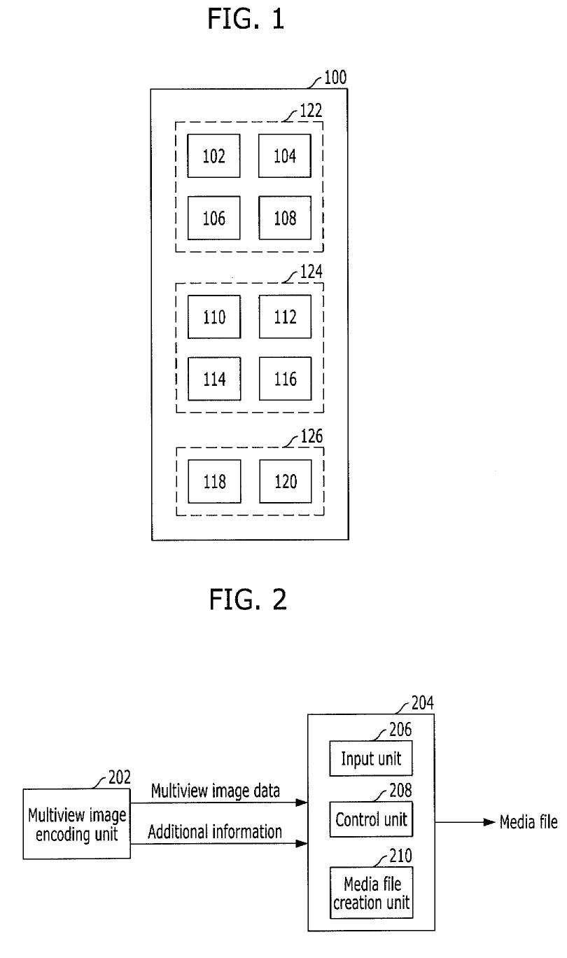

FIG. 1 illustrates the construction of a tiled multiview image, which is used in a method for creating and consuming multiview image media files in accordance with an embodiment of the present invention.

In general, High Definition (HD)-grade images have resolution of 1920×1080. However, tiled multiview images may, in some cases, have Ultra Definition (UD)-grade resolution. For example, the tiled multiview image 100 shown in FIG. 1 consists of ten view images 102 to 120, which are in a 2×5 array. Assuming that each view image has resolution of 900×400, the tiled multiview image 100 has UD-grade resolution of 1800×2000.

As such, when a tiled multiview image has UD-grade resolution, it cannot be processed by a conventional codec or system for processing HD-grade images. Therefore, the present invention divides a tiled multiview image into at least one image group including at least one view image, and creates a media file including the image group. The media file created in this manner can be processed by a conventional codec or system for processing images of HD-grade resolution or less.

Referring to FIG. 1, in accordance with an embodiment of the present invention, a tiled multiview image 100 is divided into three image groups 122, 124, and 126. Each image group 122, 124, and 126 includes at least one view image. For example, the image group 122 includes four view images 102, 104, 106, and 108, and the image group 126 includes two view images 118 and 120. As a result, the tiled multiview image 100 having resolution of 1800×2000 is divided into two image groups 122 and 124 having resolution of 1800×800 and an image group 126 having resolution of 1800×400. Each of the resulting image groups can be processed by a system supporting resolution of 1920×1080. It is obvious to those skilled in the art that the arrangement (2×5) and grouping of the tiled multiview image can be varied in respective embodiments.

When a tiled multiview image 100 is divided into at least one image group 122, 124, and 126, which is then used to create a media file, as in the case of FIG. 1, the media file may include information regarding the tiled multiview image 100. For example, when a consumer wants to play a media file, he/she needs to be provided with information indicating that the media file includes a tiled multiview image, information regarding the number of view images included in the tiled multiview image, information regarding the order of playing the view images, etc. Such information regarding the tiled multiview image will hereinafter be referred to as multiview type information.

A method and an apparatus for creating and consuming multiview image media files in accordance with an embodiment of the present invention will now be described with reference to the tiled multiview image 100 shown in FIG. 1. It will be obvious to those skilled in the art that, although the following embodiment will be described with reference to the tiled multiview image 100 shown in FIG. 1, tiled multiview images having different arrangement and grouping may also be used in accordance with the present invention.

FIG. 2 illustrates the construction of a system including an apparatus for creating multiview image media files in accordance with an embodiment of the present invention.

Referring to FIG. 2, a multiview image encoding unit 202 is configured to output multiview image data and additional information, and an apparatus 204 for creating multiview image media files in accordance with an embodiment of the present invention is configured to receive the multiview image data and the additional information and creates a media file.

In accordance with an embodiment of the present invention, the multiview image encoding unit 202 is configured to receive a multiview image and output multiview image data, i.e. Elementary Stream (ES), and additional information regarding the multiview image data, i.e. Elementary Stream Interface (ESI). The multiview image data may be tiled multiview image data.

The apparatus 204 for creating multiview image media files includes an input unit 206, a control unit 208, and a media file creation unit 210.

The input unit 206 is configured to receive tiled multiview image data outputted from the multiview image encoding unit 202. The input unit 206 may also be configured to receive additional information outputted from the multiview image encoding unit 202.

The control unit 208 is configured to divide tiled multiview image data, which has been inputted through the input unit 206, into at least one image group including at least one view image. In accordance with an embodiment of the present invention, the control unit 208 is configured to receive a tiled multiview image as shown in FIG. 1 and divide it into three image groups 122, 124, and 126.

The media file creation unit 210 is configured to create a media file including at least one image group created by the control unit 208. The media file created by the media file creation unit 210 may include information regarding the inputted tiled multiview image data, i.e. multiview type information. The multiview type information may be created by the media file creation unit 210 or by a separate multiview type information creation unit (not shown in FIG. 1). The media file creation unit 210 or the multiview type information creation unit may create multiview type information using the additional information inputted through the input unit 206.

The multiview type information refers to information regarding tiled multiview image data, and may include image group index information, view image number information, column number information, row number information, playback order information, image type information, etc.

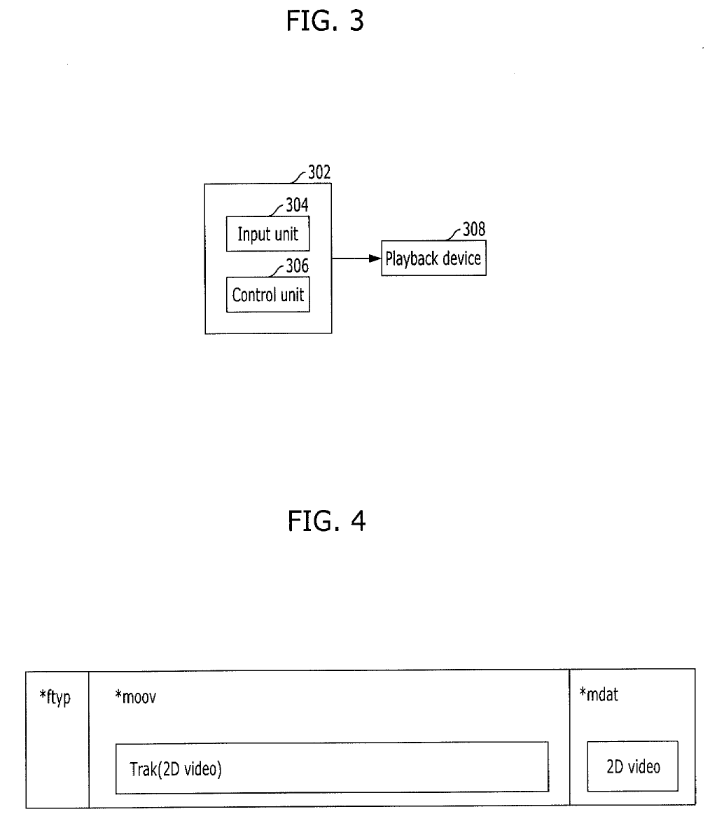

FIG. 3 illustrates the construction of a system including an apparatus for consuming multiview image media files in accordance with an embodiment of the present invention.

An apparatus 302 for consuming multiview image media files in accordance with an embodiment of the present invention is configured to receive a media file and control the multiview image playback of a playback device 308 using the media file.

The apparatus 302 for consuming multiview image media files includes an input unit 304 and a control unit 306.

The input unit 304 is configured to receive a media file including tiled multiview image data, which consists of at least one image group including at least one view image, and multiview type information.

The control unit 306 is configured to control playback of the inputted tiled multiview image data using the multiview type information inputted through the input unit 304. For example, the control unit 306 may determine the order of combining image groups using the image group index information included in the multiview type information, or determine the order of playing view images included in the image groups using the playback order information.

The playback device 308 is configured to play multiview images based on multiview image provision and control by the apparatus 302 for consuming multiview image media files.

FIG. 4 illustrates an exemplary conventional file storage structure for providing a one- or two-dimensional moving image service.

Referring to FIG. 4, the conventional file storage structure includes a ftyp box for recording information regarding the type of a file, a moov box for containing control information for playing video stored in the file, and a mdat box for recording at least one piece of video data and metadata regarding it. The moov box includes a trak box containing control information necessary to play video stored in the file and related additional information. Different trak boxes exist for respective types of video stored in the file. In the case of a file consisting of one piece of 2D video, as shown in FIG. 4, one trak box exists.

Following Table 1 shows an exemplary list of ftyp values, together with their contents, for differentiating multiview image services in the file storage structure shown in FIG. 4.

TABLE 1

| Value | Contents |
|---|---|
| 0 | Reserved |
| MV01 | Multiview moving image service |
| MV02 | Multiview still image service |

In Table 1, the multiview moving image service refers to a service providing multiview moving images during playback time, and the multiview still image service refers to a service providing multiview slide shows during playback time.

The conventional file structure as shown in FIG. 4 is mainly focused on 2D contents services, making provision of multiview image services limited.

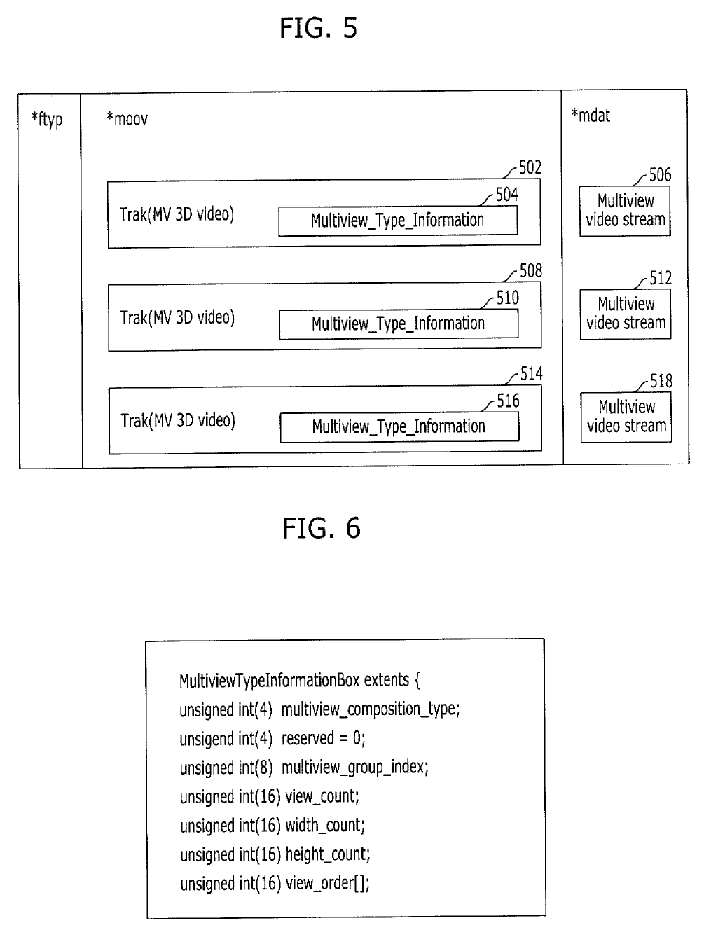

FIG. 5 illustrates a multiview image file storage structure in accordance with an embodiment of the present invention.

FIG. 5 shows a file structure for storing a tiled multiview image 100, which has been divided into three image groups 122, 124, and 126 as shown in FIG. 1.

Referring to FIG. 5, the multiview image file in accordance with an embodiment of the present invention includes a ftyp box, a moov box, and a mdat box as in the case of the conventional file structure. However, since the tiled multiview image 100 is divided into three image groups 122, 124, and 126 as shown in FIG. 1 in accordance with the present invention, respective image groups 122, 124, and 126 are contained in the mdat box as separate video streams 506, 512, and 518, and trak boxes 502, 508, and 514 corresponding to respective video streams 506, 512, and 518 are contained in the moov box.

Respective trak boxes 502, 508, and 514 contain multiview type information 504, 510, and 516, i.e. information regarding the tiled multiview image data.

FIG. 6 illustrates multiview type information in accordance with an embodiment of the present invention.

Referring to FIG. 6, the multiview type information in accordance with an embodiment of the present invention includes image type information (multiview_composition_type), image group index information (multiview_group_index), view image number information (view_count), column number information (width_count), row number information (height_count), and playback order information (view_order[ ]). Referring to FIG. 5, the multiview type information in accordance with an embodiment of the present invention is described as a box 504, 510, and 516 inside the trak box. However, the above-mentioned pieces of information included in the multiview type information may be described as separate boxes in an alternative embodiment.

The image type information indicates the composition type of multiview images included in the corresponding file. As explained above, ftyp can be used to indicate that video data included in the corresponding file is a multiview image, and the image type information corresponds to information regarding detailed composition of multiview images. Following Table 2 shows respective values and contents of video type information in accordance with an embodiment of the present invention.

TABLE 2

| Value | Contents |
|---|---|
| 0 | Reserved |
| 1 | Tiled |
| 2 | Reserved for other multiview image type |

In Table 2, value 1 indicates that video data included in the corresponding file is “tiled” multiview image data, and value 2 corresponds to an image of a type other than the tiled multiview image.

The image group index information is used, when a tiled multiview image is divided into at least one group, to indicate the index of each group (or trak box corresponding to each box). For example, when a tiled multiview image 100 is divided into groups 122, 124, and 126 as shown in FIG. 1, group 122 may have index 1, group 124 index 2, and group 126 index 3 as image group index information. The image group index information may be used, when each image group is combined to play the tiled multiview image, to determine the order of combining the image groups. In other words, the image group index information is used to indicate the interrelation between each image group (or each trak).

The view image number information indicates the number of view images included in each image group. For example, the group 122 shown in FIG. 1 includes four view images 102 to 108, and view image number information regarding the group 122 is four. Similarly, the group 126 has view image number information of two. In summary, the view image number information indicates the number of view images included in each image group (or each trak).

When an image group includes N×N view images, N corresponds to column number information, and M corresponds to row number information. For example, the group 126 shown in FIG. 1 includes 2×1 view images, so column number information regarding the group 126 is two, and row number information is 1. The view image number information, the column number information, and the row number information may be used, when playback of a tiled image is controlled, to determine the number and arrangement of view images included in each image group.

The playback order information indicates the order of playing view images included in each image group. For example, when an image group, e.g. the group 122 shown in FIG. 1, includes four view images 102 to 108, the order of playing respective view images may vary in each case.

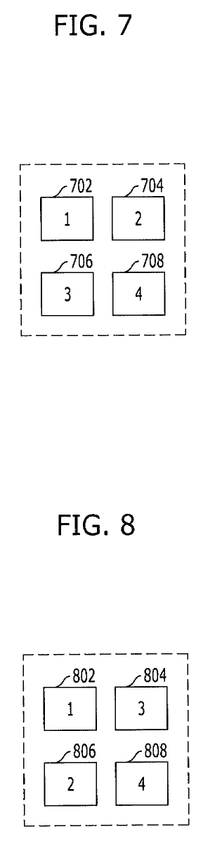

FIGS. 7 and 8 illustrate the construction of playback order information based on the order of playing view images included in an image group.

FIGS. 7 and 8 correspond to a case in which an image group includes 2×2 view images. The number inside each view image 702 to 708 and 802 to 808 corresponds to the order of playing each view image. For example, the view images of FIG. 8 will be played in the order of: 802, 806, 804, and 808.

In FIGS. 7 and 8, view_order[0] indicates the playback order of (0,0)^{th} view image 702 or 802, and view_order[1] indicates the playback order of (0,1)^{th} view image 704 or 804. To generalize this, view_order[N*M−1] indicates the playback order of (N−1, M−1)^{th} view image.

Therefore, the playback order information of FIG. 7 is: view_order[ ]={1, 2, 3, 4}, and the playback order information of FIG. 8 is: view_order[ ]={1, 3, 2, 4}.

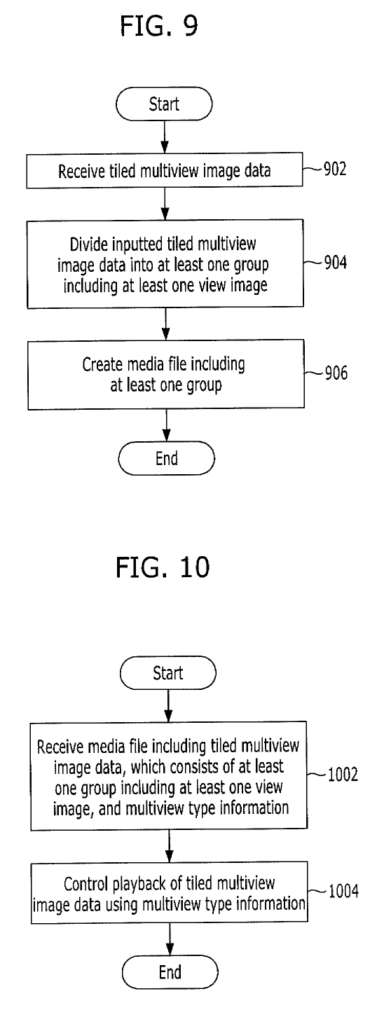

FIG. 9 is a flowchart illustrating a method for creating multiview image media files in accordance with an embodiment of the present invention.

A tiled multiview image data is received at step S902. The inputted tiled multiview image data is divided into at least one image group including at least one view image at step S904. A media file including at least one group is created at step S906. The created media file includes information regarding the tiled multiview image data, i.e. multiview type information. The multiview type information includes at least one of image type information, image group index information, view image number information, column number information, row number information, and playback order information.

FIG. 10 is a flowchart illustrating a method for consuming multiview image media files in accordance with an embodiment of the present invention.

A media file including tiled multiview image data, which consists of at least one group including at least one view image, and multiview type information is received at step S1002. Playback of the tiled multiview image data is controlled using the multiview type information included in the media file at step S1004. The created media file includes information regarding the tiled multiview image data, i.e. multiview type information. The multiview type information includes at least one of image type information, image group index information, view image number information, column number information, row number information, and playback order information. When playback of the tiled multiview image data is controlled using the multiview type information at the step S1004, the order of combining the image groups can be determined using the image group index information, and the order of playing view images included in the image groups can be determined using the playback order information.

As mentioned above, in accordance with the exemplary embodiments of the present invention, a tiled multiview image service can be provided more efficiently while maintaining compatibility with existing multiview image systems.

Furthermore, multiview images of better quality compared with conventional depth-based multiview image services are provided.

In addition, the complexity of multiview image service systems is decreased, and the amount of data necessary for multiview image encoding is substantially reduced.

While the present invention has been described with respect to the specific embodiments, it will be apparent to those skilled in the art that various changes and modifications may be made without departing from the spirit and scope of the invention as defined in the following claims.

What is claimed is:

1. A method for creating a multiview image media file, comprising:
receiving tiled multiview image data;
dividing the tiled multiview image data into at least one image group comprising at least one view image; and
creating a media file comprising the at least one image group, wherein
the media file comprises multiview type information, the multiview type information being information regarding the tiled multiview image data.

2. The method of claim 1, wherein the multiview type information comprises image group index information indicating an order of combining the at least one image group.

3. The method of claim 1, wherein the multiview type information comprises view image number information indicating the number of view images belonging to the at least one image group.

4. The method of claim 1, wherein the at least one image group comprises N(number of columns)×M(number of rows) view images, and the multiview type information comprises column number information and row number information.

5. The method of claim 4, wherein the multiview type information comprises playback order information indicating an order of playing view images belonging to the at least one image group.

6. The method of claim 1, wherein the multiview type information comprises image type information indicating that the media file comprises a tiled multiview image.

7. A method for consuming a multiview image media file, comprising:
receiving a media file comprising tiled multiview image data and multiview type information, the tiled multiview image data comprising at least one image group comprising at least one view image, the multiview type information being information regarding the tiled multiview image data; and
controlling playback of the tiled multiview image data using the multiview type information.

8. The method of claim 7, wherein the multiview type information comprises image group index information indicating an order of combining the at least one image group, and
the controlling playback of the tiled multiview image data using the multiview type information comprises determining the order of combining the image group using the image group index information.

9. The method of claim 7, wherein the multiview type information comprises view image number information indicating the number of view images belonging to the at least one image group.

10. The method of claim 7, wherein the at least one image group comprises N(number of columns)×M(number of rows) view images, and the multiview type information comprises column number information and row number information.

11. The method of claim 10, wherein the multiview type information comprises playback order information indicating an order of playing view images belonging to the at least one image group, and
the controlling playback of the tiled multiview image data using the multiview type information comprises determining the order of playing the view images using the playback order information.

12. The method of claim 7, wherein the multiview type information comprises image type information indicating that the media file comprises a tiled multiview image.

13. An apparatus for creating a multiview image media file, comprising:
an input unit configured to receive tiled multiview image data;
a control unit configured to divide the tiled multiview image data into at least one image group comprising at least one view image; and
a media file creation unit configured to create a media file comprising the at least one image group, wherein
the media file comprises multiview type information, the multiview type information being information regarding the tiled multiview image data.

14. An apparatus for consuming a multiview image media file, comprising:
an input unit configured to receive a media file comprising tiled multiview image data and multiview type information, the tiled multiview image data comprising at least one image group comprising at least one view image, the multiview type information being information regarding the tiled multiview image data; and
a control unit configured to control playback of the tiled multiview image data using the multiview type information.
